(19) United States
(12) Patent Application Publication
(10) Pub. No.: US 2007/0059526 A1
(43) Pub. Date: Mar. 15, 2007

(54) Microcapsules for the production of storage-stable unsaturated polymer compositions

(76) Inventors: Klaus-Wilhelm Lienert, Hamburg (DE); Gunter Hegemann, Hamburg (DE); William D Dunbar, Ghent, NY (US); Ivan Sheiham, Buckinghamshire (GB); Timothy Edward Banach, Scotia, NY (US)

Correspondence Address: PILLSBURY WINTHROP SHAW PITTMAN, LLP, P.O. BOX 10500, MCLEAN, VA, 22102, US

(21) Appl. No.: 10/511,172

(22) PCT Filed: Apr. 14, 2003
(86) PCT No.: PCT/EP03/03836

§ 371 Date: Mar. 16, 2005

(30) Foreign Application Priority Data
Apr. 15, 2002 (DE) 10216550.5

(51) Int. Cl. B32B 9/00

(52) U.S. Cl. 428/402.2

(57) ABSTRACT

The present invention relates to microcapsules containing polymerization initiators, a process for their preparation and their use.

The present invention relates to microcapsules which are suitable for the formulation of storage-stable polymer compositions, in particular of unsaturated polyester resins, and to their preparation and use.

Microcapsules are known in the technical literature. There are those whose capsule shell consist of polyurethanes, as described, for example, in DE 198 40 582 and DE 198 40 583. Melamine resins are described in DE 198 35 114 and DE 198 33 347, likewise as materials for capsule shells.

The use of capsules for protecting the chemicals enclosed therein is likewise known. There is a great deal of literature about encapsulated bioactive substances. However, other chemicals, too, are enclosed in a polymer shell. JP 01 279 930 A2 and JP 2 513 269 B2 describe the encapsulation of benzoyl peroxide for the vulcanization of rubber. In JP 200 026 829 A2, an epoxy resin adduct which acts as an adhesive is encapsulated.

U.S. Pat. No. 4,362,566 describes the use of hollow microspheres which are filled with a peroxide-containing paste for the formulation of unsaturated polyester resins. The material of the hollow microspheres and their production are not described in detail. With a diameter of 20 μm, they are very coarse. Moreover, the hollow spheres have to be mechanically destroyed, for example by means of a suitable pump or an extruder, in order to release the peroxide. The use of the formulations is therefore limited to applications in which mechanical action on the system are possible, e.g. encapsulation. Use in a dip tank produces no progress compared with a conventional system. An additional process step which serves for destroying the hollow microspheres as completely as possible is in any case necessary during processing.

Unsaturated polyester resins are formulations which contain unsaturated polyesters and which cure during use with polymerization and crosslinking to give thermosetting materials (cf. Römpp Chemie Lexikon, 1992 edition, page 4822). The fields of use for unsaturated polyester resins are, inter alia, also the production of shaped articles and semifinished products from glass fiber-reinforced casting resins (H. Hagen in Glasfaserverstärkte Kunststoffe [Glass fiber-reinforced plastics], Springer, 1956, Ullmanns Enzyklopädie der technischen Chemie [Ullmann's Encyclopedia of Industrial Chemistry]), the impregnation of electrical windings (M. Winkeler et al. in New developments in unsaturated polyester resins used for electrical insulation, EIC Technical Conference, Cincinnati, 2001).

Unsaturated polyesters are polycondensates obtained from mixtures of bifunctional carboxylic acids or derivatives thereof (anhydrides, esters, etc.), of which at least one must be unsaturated, and bifunctional alcohols and/or epoxy resins.

Acids usually used are adipic, glutaric, phthalic, isophthalic and terephthalic acid as a mixture with maleic acid (anhydride), fumaric acid, Diels-Alder adducts of maleic anhydride and cyclopentadiene, in some cases acrylic and methacrylic acid.

Difunctional alcohols used are ethylene glycol, diethylene glycol, propylene glycol, dipropylene glycol, neopentyl glycol and 1,4-butanediol, bisphenol A diglycidyl ether and many others.

Branched unsaturated polyesters are obtained by using trifunctional molecules such as, for example, trimellitic anhydride, trimethylolpropane, pentaerythritol or tris(hydroxyethyl) isocyanurate.

In combination with unsaturated monomers, unsaturated polyesters are polymerizable by means of curing agents (i.e. polymerization initiators).

Unsaturated monomers which may be used are, for example, vinylic monomers, such as, for example, styrene, alpha-methylstyrene, vinyltoluene, vinylpyrrolidone, vinylcaprolactam, (meth)acrylates such as, for example, methyl methacrylate, vinyl ethers, such as, for example, cyclohexyl vinyl ether, ethylene glycol butyl vinyl ether, etc. Difunctional monomers for increasing the crosslinking density, such as, for example, diallyl phthalate, divinylbenzene, 1,6-hexanediol diacrylate or tetraethylene glycol divinyl ether, are also used. Polyfunctional molecules, such as, for example, trimethylopropane triacrylate, trimethylolpropane trivinyl ether or trimethylolpropane triallyl ether, are also used for the same purpose.

Unsaturated polyester resins additionally contain, as a rule, polymerization initiators, accelerators and stabilizers. Depending on the intended use, they may contain pigments, plasticizers, antistatic agents, fillers and reinforcing agents.

Polymerization initiators used are mainly peroxides, such as, for example, tert-butyl perbenzoate, dicumyl peroxide, etc. (cf. also technical data sheets of the various peroxide manufacturers). C-C-labile curing agents may be mentioned as nonperoxidic polymerization initiators which are suitable for use in unsaturated polyester resins. DE 21 31 623 describes linear silyl ethers which can be used for this purpose. DE 26 32 294 describes silyl ethers of benzopinacol which can likewise be used as polymerization initiators for free radical polymerization reactions.

Unsaturated polyester resins which are formulated with a polymerization initiator are activated and thus have limited stability at room temperature. The prior art procedure is therefore either to store resin and polymerization initiator separately and not to mix them until just before use or to optimize the reactivity and the storage stability by careful formulation with the components resin, curing agent and stabilizers. In accordance with the prior art, stabilizers used today are quinones, e.g. p-benzoquinone, etc., and/or substituted phenols, e.g. di-tert-butylphenol, etc. Neither of the two variants is optimum for the processor as they entail additional effort since either the [lacuna] must be mixed from resin and polymerization initiator or the activated resins must be stored at temperatures which are as low as possible in order to obtain a correspondingly good storage stability.

It is the object of the present invention to provide a storage-stable one-component system comprising polymerization initiator and unsaturated polymer composition which can be used in the customary applications and can be processed on the conventional apparatuses.

This object is achieved by microcapsules containing at least one polymerization initiator.

The microcapsules according to the invention are distinguished by the fact that they are stable when stored normally, in particular at room temperature, and decompose only at relatively high temperature and thereby release the polymerization initiator.

The microcapsules are preferably designed in such a way that they decompose at the curing temperature of the unsaturated polymer compositions to be cured. The polymerization initiator is released thereby so that the polymerization can be initiated.

The capsule shell preferably contains organic polymers. In a preferred variant, it consists of these. Polymers which are described in the prior art for microcapsules can be used here. These include, for example, polyurethanes or melamine resins. Epoxy resins are preferably used as the capsule shell for the present invention.

The polymerization initiators enclosed in the capsules can preferably be organic peroxides, such as, for example, tert-butyl perbenzoate, a paste of dibenzoyl peroxide in dimethyl phthalate. Also preferred are C-C-labile compounds, as described, for example, in DE 26 32 294. A C-C-labile compound is preferably prepared from benzophenone and methyl trichlorosilane. The microcapsules according to the invention preferably have a diameter of less than 20 μm, particularly preferably from 3 to 15 μm.

The microcapsules can be introduced into unsaturated monomer or polymer systems, and storage-stable one-component systems are thus obtained. Such systems are preferably storage-stable at room temperature. At higher temperature, the capsule shells decompose and the polymerization initiators are released, so that the polymerization can start. Preferably used capsule shells are those which decompose at the curing temperature of the polymer composition.

Unsaturated polymers used are preferably polyesters or imide-modified polyesters. The microcapsules according to the invention are preferably used in formulations which [lacuna]
a) one or more unsaturated polyesters which are dissolved in
b) one or more unsaturated monomers.

In addition, the formulations could contain:
c) fillers, pigments and various assistants
d) stabilizers and accelerators
d) an initiator which is enclosed in microcapsules comprising a plastic,

The formulations can preferably contain 0.1-10% by weight of the encapsulated polymerization initiator according to the invention, preferably 0.5-8, particularly preferably 1.0-5.0, % by weight %.

According to the invention, it was was surprisingly found that, for establishing the same gel time (DIN 16945) of the unsaturated polyester resins, less C-C-labile curing agent is required if this is added in the form of capsules.

The present invention furthermore relates to a process for the production of the microcapsule according to the invention. This process is characterized in that
a) a solution containing a polymerization initiator for the organic polymer used for the production of the capsule shell is prepared,
b) a solution containing the organic polymer and polymerization initiator is prepared,
c) the solutions are mixed and
d) if required, processed to give a powder.

In step c), the two solutions a) and b) are preferably mixed to a droplet size of 1 to 20 μm, particularly preferably of 3 to 15 μm.

Suitable stirrers known from the prior art are used for this purpose.

When reaching the desired droplet size, the stirrer speed is, if required, reduced and the mixture is, if required, kept at a temperature of 60 to 90° C., preferably of 75 to 85° C. If required, cooling is then effected. The powder is preferably prepared by spray-drying. For example, the process according to EP 0 074 050 B1 is suitable for this purpose.

The invention furthermore relates to the use of the microcapsule described for the polymerization of unsaturated polymeric compositions, in particular polyesters.

The microcapsules are also used for the preparation of one-component systems comprising the unsaturated polymers described.

The microcapsules according to the invention and the formulations described, comprising the microcapsules, can be used for the preparation of casting resins and impregnating resins and of fiber-reinforced polymers, in particular polyester resins. These serve, for example, for the production of shaped articles and semifinished products.

The invention is described in more detail below with reference to examples. The preparation of the encapsulated polymerization initiators and, by way of example, their use in the formulation of unsaturated polyester resins which can have a very wide range of applications are described.

### EXAMPLES

### Example 1

### Production of Capsules I

A solution is prepared from 476 g of water, 3 g of commercial protective colloid, 21 g of a commercial anionic surfactant, 6 g of 2-methylimidazole and 6 g of a commercial epoxy resin curing agent (e.g. Epicure 3271 from Shell).

A solution is prepared from 325 g of a high-boiling naphtha, 26 g of a commercial epoxy resin (e.g. Epikote 828 from Shell) and 36 g of the C-C-labile curing agent.

The two solutions are mixed and are finely distributed in one another using a high-speed stirrer (about 2 000 rpm). When the desired droplet size, e.g. 10 μm, is reached, the speed is reduced and the batch is kept at 80° C. for several hours. Cooling is then effected and the material obtained is spray-dried. A fine powder which consists of the curing agent in an epoxy resin shell is obtained.

### Example 2

### Production of Capsules II

A solution is prepared from 400 g of water, 3 g of a commercial protective colloid, 24 g of an anionic surfactant, 7 g of 2-methylimidazole and 4 g of diethylenetriamine.

A solution is prepared from 300 g of a commercial high-boiling naphtha, 100 g of a high-boiling ether, 52 g of a commercial epoxynovolak (e.g. ECN 1273 from DOW) and 100 g of the C-C-labile curing agent.

The two solutions are mixed and are finely distributed in one another using a high-speed stirrer (about 5 000 rpm). When the desired droplet size, e.g. 15 μm, is reached, the speed is reduced and the batch is kept at 80° C. for several hours. Cooling is then effected and the material obtained is spray-dried. A fine powder which consists of the curing agent in an epoxy resin shell is obtained.

### Example 3

### Unsaturated Polyester Resin 1 with Capsule I

An unsaturated polyester resin which contains 35% of styrene, whose resin component has an acid number of 25 mg KOH/g and which has a viscosity of 500 mPas at 23° C., is formulated with 1% of capsules I. The gel time of the composition is 8 minutes at 120° C. The pot life at 40° C. is 52 days. If 2% of capsules are used, the gel time is 6 minutes at 120° C. and the pot life is likewise 52 days at 40° C. The pot life at 40° C. is thus independent of the amount of capsules used.

### Example 4

### Comparative Example

An unsaturated polyester resin which contains 35% of styrene, whose resin component has an acid number of 25 mg KOH/g and which has a viscosity of 500 mPas at 23° C., is formulated with 0.5% of C-C-labile curing agent. The gel time is 3.3 minutes at 120° C. The pot life is 24 days at 40° C. If 1% of curing agent is used, the gel time is 3 minutes and the pot life is 4 days at 40° C.

### Example 5

### Comparison of the Activities

An unsaturated polyester resin which contains 35% of styrene, whose resin component has an acid number of 25 mg KOH/g and which has a viscosity of 500 mPas at 23° C., is formulated with 0.5% of C-C-labile curing agent. The gel time is 3.3 minutes at 120° C. If 3% of capsules I (in this case, the amount of curing agent from the capsules is 0.3%) are used, the gel time is 3.8 minutes at 120° C. In spite of the small amount of curing agent, comparable gel times are obtained.

### Example 6

### White Resin

An unsaturated polyester resin which contains 35% of styrene, whose resin component has an acid number of 25 mg KOH/g and which has a viscosity of 500 mPas at 23° C., is pigmented with 40% of titanium dioxide and then formulated with 2% of capsules I. A choke coil is impregnated therewith and then cured for 2 hours at 140° C. The impregnation was satisfactory.

### Example 6

### Casting Resin

10% of short glass fibers and 30% of dolomite are incorporated into an unsaturated polyester resin which contains 35% of styrene, whose resin component has an acid number of 25 mg KOH/g and which has a viscosity of 500 mPas at 23° C. Formulation is then effected with 2% of capsules I. Standard test pieces produced therewith were cured for 2 hours at 140° C. The appearance and testing correspond to the standard.

### Example 7

### Unsaturated Polyester Resin 2 with Capsules II

An unsaturated polyester resin which contains 40% of vinyltoluene, whose resin component has an acid number of 10 mg KOH/g and which has a viscosity of 350 mPas at 23° C., is formulated with 1% of capsules II. The gel time is 5 minutes at 120° C. Storage of the resin formulation at room temperature produces no change in the viscosity and reactivity after 200 days.

1-13. (canceled)

14. A microcapsule comprising at least one polymerization initiator.

15. The microcapsule of claim 14, wherein the polymerization initiator is capable of initiating the polymerization of unsaturated polyester resins.

16. The microcapsule of claim 14, wherein the polymerization initiator is a free radical initiator.

17. The microcapsule of claim 14, wherein the polymerization initiator is a C-C-labile compound.

18. The microcapsule of claim 14, wherein the capsule shell of the microcapsule is designed in such a way that it decomposes at the curing temperature of the polymer composition to be cured.

19. The microcapsule of claim 14, wherein the capsule shell of the microcapsule comprises one or more organic polymers.

20. The microcapsule of claim 14, wherein the capsule shell of the microcapsule comprises polyurethanes, melamine resins, epoxy resins or mixtures thereof.

21. A process for the production of a microcapsule, comprising the steps of:
(a) preparing a solution containing a polymerization initiator used for the production of a capsule shell,
(b) preparing a solution containing an organic polymer and a polymerization initiator,
(c) mixing the solutions to form a mixture, and
(d) if necessary, processing the mixture to produce a powder.

22. The process of claim 21, wherein, in step (c), the solutions are mixed via stirring with one another to a droplet size ranging from 1 to 20 μm.

23. The process of claim 22, wherein the solutions are mixed to a droplet size ranging from 3 to 15 μm.

24. The process of claim 21, wherein the mixture obtained from step (c) is cooled and spray-dried in step (d).

25. A process for polymerizing a polyester resin, comprising the steps of:
(a) introducing a polyester resin capable of being polymerized,
(b) polymerizing the polyester resin with a microcapsule comprising at least one polymerization initiator.

26. The process of claim 25, wherein said polyester resin is a casting resin or an impregnating resin.

27. The process of claim 25, wherein said polyester resin is a fiber-reinforced unsaturated polyester resin.
